(19) United States
(12) Patent Application Publication
(10) Pub. No.: US 2018/0216813 A1
(43) Pub. Date: Aug. 2, 2018

(54) ENERGY EFFICIENT LIGHTING PLATFORM AND SYSTEM

(71) Applicant: The Pennsylvania Globe Gaslight Co., North Branford, CT (US)

(72) Inventor: Marcia LaFemina, Madison, CT (US)

(73) Assignee: The Pennsylvania Globe Gaslight Co., North Branford, CT (US)

(21) Appl. No.: 15/928,835

(22) Filed: Mar. 22, 2018

Related U.S. Application Data
(63) Continuation of application No. 14/326,011, filed on Jul. 8, 2014, now abandoned.
(60) Provisional application No. 61/844,195, filed on Jul. 9, 2013.

(51) Int. Cl. F21V 33/00; F21V 15/01; F21V 29/70; G08B 13/196; H04N 5/225; F21W 131/10

(52) U.S. Cl. CPC F21V 33/0052; F21V 15/01; F21V 33/0076; F21W 2131/10; G08B 13/19619; G08B 13/19632; H04N 5/2256; F21V 29/70

(57) ABSTRACT

An energy efficient lighting and surveillance system includes a housing; a backing substrate; a plurality of LED array boards located within the housing and attached to the backing substrate; and a surveillance device extending from the housing and attached to the backing substrate.

### CROSS-REFERENCE TO RELATED APPLICATION

This application is a continuation of, and claims the benefit of co-pending U.S. patent application Ser. No. 14/326,011, filed on Jul. 8, 2014, which claims the benefit of U.S. Provisional Patent Application No. 61/844,195, filed on Jul. 9, 2013. The contents of both applications are incorporated herein by reference in their entireties.

### TECHNICAL FIELD

The present disclosure generally relates to energy efficient lighting platforms and systems.

### BACKGROUND

There are many different types, styles and designs of exterior and interior lighting devices available on the market. However, most of these designs are not suitable for illuminating, e.g. streets and so forth, where the distribution of emitted light must meet rigorous standards as to glare, cutoff angle, throw and direction of emitted light, as well as the shape and size of the lighted area. Recognized industry groups including the Illuminating Engineering Society (IES) set predetermined illumination distribution standards, such as Type II, Type III and Type IV distribution patterns, among others. Lighting engineers designing, e.g., street lighting use these recognized industry standards to specify the desired lighting. A light capable of meeting these recognized illumination distribution standards, e.g., Type II, Type III and so forth, are highly engineered and complex.

In addition to meeting the afore-referenced illumination distribution standards, many lighting devices must also address control over the lighting distribution to limit objectionable light pollution and glare. One such solution is set forth in U.S. Pat. No. 6,474,848 assigned to the present assignee and hereby incorporated by reference. As disclosed in U.S. Pat. No. 6,474,848, an exterior light includes a base, a transparent enclosure mounted on the base, a bulb mounted within the enclosure on a vertically adjustable bulb holder, a shield mounted on the bulb holder for adjustable movement relative to the bulb and an upper dome cooperating with the bulb to produce an illumination distribution. As the bulb holder is vertically adjusted, the shield and bulb move together. Adjustment of the bulb holder and the shield changes the illumination distribution.

Further to the above, scientists, engineers and others under the direction of the present assignee are continually seeking innovations regarding the lighting market in an effort to, e.g., improve energy efficiency, functioning and applications of lighting platforms.

Accordingly, there exists a need for lighting platforms and systems having improved energy efficiency, functioning and applications.

Embodiments of the invention address the foregoing needs and others.

### SUMMARY

According to aspects illustrated herein, there is provided an energy efficient lighting and surveillance system comprising a housing, a backing substrate, a plurality of light emitting diode (LED) array boards located within the housing and attached to the backing substrate, and a surveillance device extending from the housing and attached to the backing substrate.

According to another aspect illustrated herein, there is provided a light fixture assembly. The light fixture assembly comprises a light fixture; and an energy efficient lighting and surveillance system attached to the light fixture. The energy efficient lighting and surveillance system comprises a housing, a backing substrate, a plurality of LED array boards located within the housing and attached to the backing substrate, and a surveillance device extending from the housing and attached to the backing.

According to further aspects illustrated herein, there is provided an energy efficient lighting and surveillance system comprising a housing; a backing substrate; an induction lighting source located within the housing and attached to the backing substrate; and a surveillance device extending from the housing and attached to the backing substrate.

According to still further aspects illustrated herein, there is provided an energy efficient lighting and surveillance system. The system comprises a housing; and a a light source located within the housing. The light source comprises at least one of i) a flat light emitting diode (LED) array board with a plurality of LED bulbs thereon and having a medium or mogul base socket and ii) a protruding structure comprising a plurality of LED bulbs thereon and having a medium or mogul base socket. The system further comprises a surveillance device extending from the housing.

The above described and other features are exemplified by the following figures and in the detailed description.

### BRIEF DESCRIPTION OF THE DRAWINGS

Referring now to the figures, which are exemplary embodiments, and wherein the like elements are numbered alike:

FIG. 1 is a schematic, perspective view of an energy efficient lighting and surveillance system, according to embodiments;

FIG. 1A is a side view of FIG. 1;

FIG. 1B is a front view of FIG. 1;

FIG. 1C is a schematic perspective view of the surveillance device (dome surveillance camera) depicted in FIG. 1;

FIG. 1D illustrates an exemplary light emitting diode (LED) platform of FIG. 1, according to embodiments;

FIGS. 1E, 1F and 1G illustrate standard Type II, Type III and Type IV IES Illumination distributions, respectively, that exterior light fixture assemblies according to embodiments can be adjusted to meet;

FIG. 2 illustrates a light fixture assembly comprising a light fixture and an energy efficient lighting and surveillance system, according to embodiments;

FIG. 3 illustrates another light fixture assembly comprising an energy efficient lighting and surveillance system, according to embodiments;

FIG. 4 illustrates a schematic, perspective view of an energy efficient lighting and surveillance system, according to embodiments;

FIG. 4A is a side view of FIG. 4;

FIG. 4B is a front view of FIG. 4;

FIG. 5 illustrates a schematic, perspective view of an energy efficient lighting and surveillance system, according to embodiments, employing a medium or mogul base socket and LED lighting;

FIG. 5A is a side view of FIG. 5;

FIG. 5B is a front view of FIG. 5;

FIG. 6 illustrates a schematic, perspective view of an energy efficient lighting and surveillance system, according to embodiments, employing a medium or mogul base socket, LED lighting and a square shaped housing;

FIG. 6A is a side view of FIG. 6;

FIG. 6B is a front view of FIG. 6;

FIG. 7 illustrates a schematic, front view of an energy efficient lighting and surveillance system, according to embodiments, employing a medium or mogul base socket and LED lighting in a light fixture;

FIG. 7A is a side view of FIG. 7;

FIG. 7B is a bottom view of FIG. 7; and

FIG. 8 illustrates a light fixture assembly comprising the light fixture and energy efficient lighting and surveillance system of FIG. 7.

### DETAILED DESCRIPTION

The inventor has herein determined how to advantageously extend the functionality of lighting to serve as both energy efficiency lighting devices, as well as information servers. For example, according to embodiments, the inventor has determined a system for integrating discrete surveillance and energy efficient platforms to protect communities, facilities and institutions while also delivering energy cost savings.

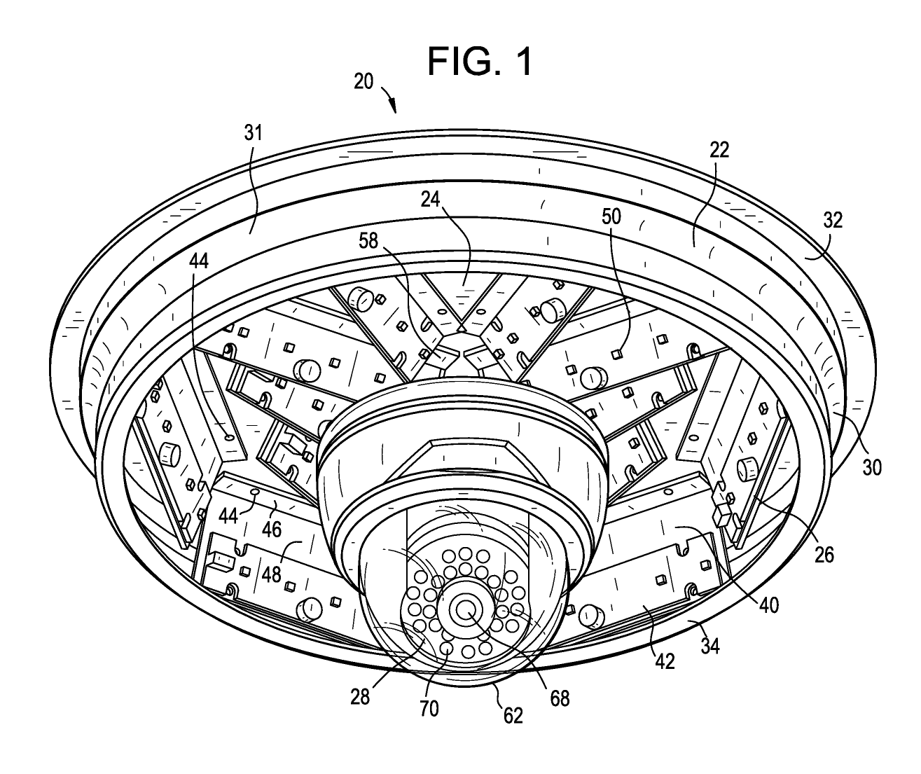

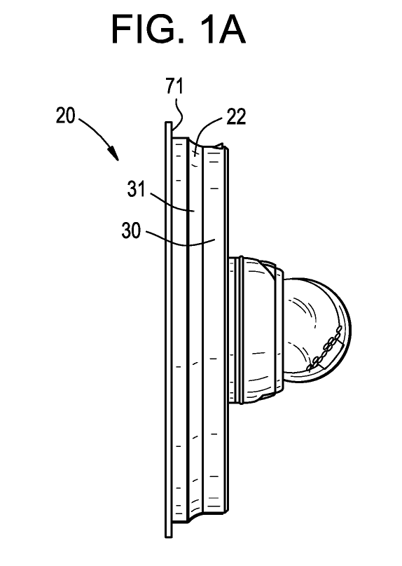

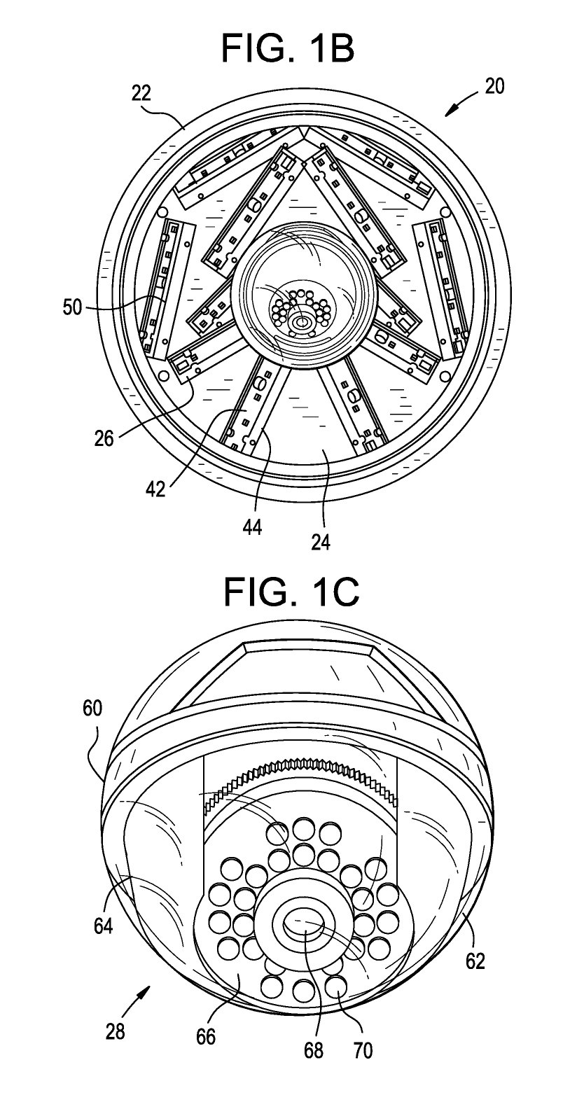

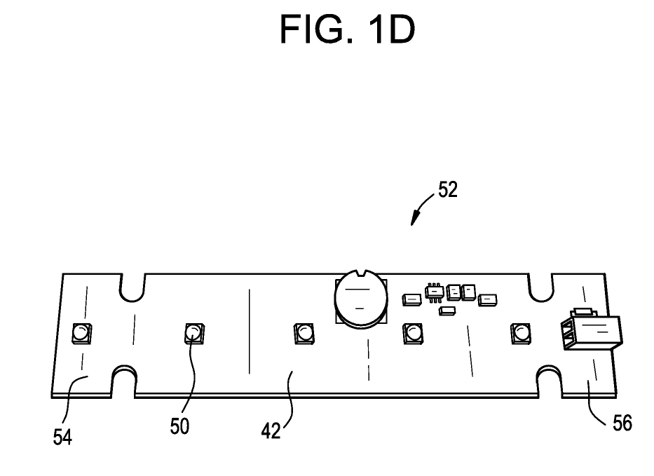

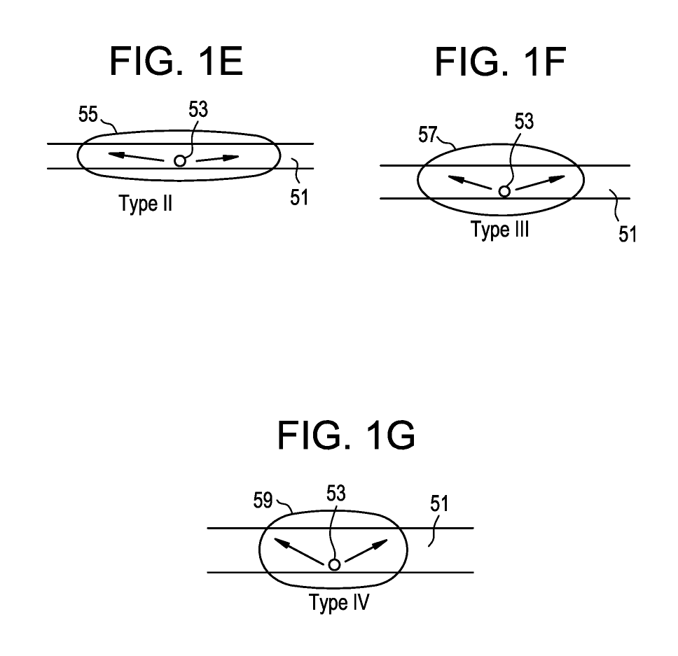

Referring now to FIG. 1, FIG. 1 is a schematic, perspective view of an energy efficient lighting and surveillance system 20, according to embodiments. The energy efficient lighting and surveillance system 20 comprises a housing 22, a backing substrate 24, a plurality of LED array boards 26 located within the housing 22 and attached to the backing substrate 24, and a surveillance device 28 extending from the housing 22 and attached to the backing substrate 24.

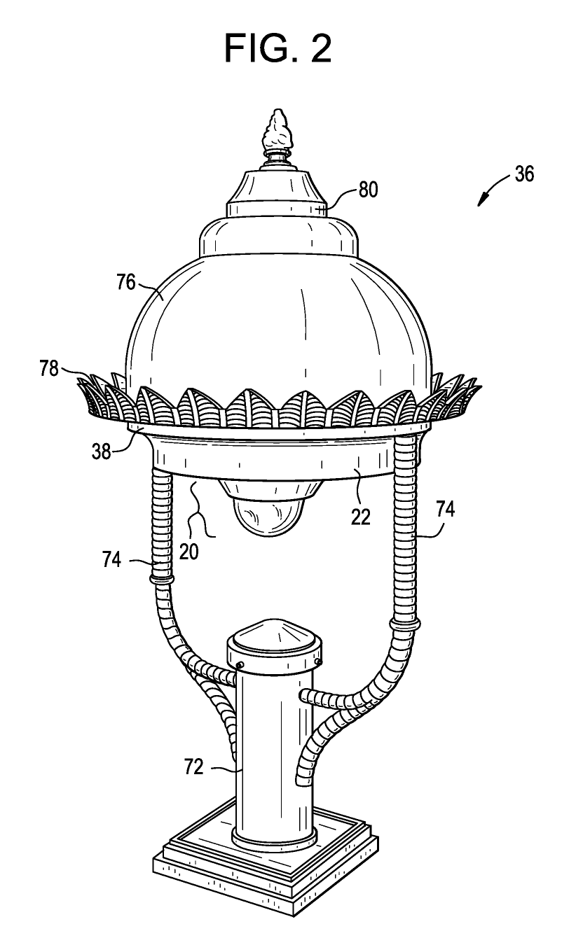

The housing 22 is typically an outer metal housing of suitable shape, size and thickness depending upon application and use. Typically, the housing 22 is made with the use of aluminum spinning or aluminum casting to a suitable thickness as desired for heat sinking and locating within another structure, such as a light fixture. The housing 22 also is typically black powder aluminum coated to provide outdoor water resistance and weather protection. In the exemplary embodiment shown in FIG. 1, the housing 22 is shaped as a hollow, circular, rim or ring-like structure. The housing 22 shown in FIG. 1 also comprises a side wall 30 of suitable thickness and height. As best seen in FIG. 1A, the side wall 30 can comprise a ridge 31. The side wall 30 is located between a first 32 edge and a second edge 34 of the housing 22 in the embodiment depicted in FIG. 1. The first edge 32 and the second edge 34 are shown therein as lips extending beyond the diameter of the side wall 30 which forms the afore-reference rim or ring-like structure of the housing 22. The first edge 32 and the second edge 34 can function as positioning structures. For example, typically the energy efficient lighting and surveillance system 20 is mounted in the upper portion, e.g., roof, of another structure, such as the light fixture assembly 36 shown in FIG. 2, with the first edge 32 secured to portion of the light fixture 38 of the light fixture assembly 36.

A flat, backing substrate 24 is located within the housing 22 to provide a positioning backing surface for locating the system 20 into another structure, such as the roof or upper portion of the light fixture 38 shown in FIG. 2, as noted above. The backing substrate is secured within the housing 22 by any suitable securing mechanism, such as screws, adhesive and so forth. The backing substrate 24 is made of suitable shape, size, thickness and material and, as shown in FIG. 1, conforms to the housing 22 to fit within the side walls 30 and locate the system 20 within another structure. The backing substrate 24 is typically made from a metallic material, such as aluminum. The backing substrate 24 can comprise attachment devices, such as screws, snaps, pins, other fasteners and so forth for securing the system 20 within another structure. Alternatively, or additionally, the first edge 32 could also comprise such attachment devices for assistance in securing the system 20.

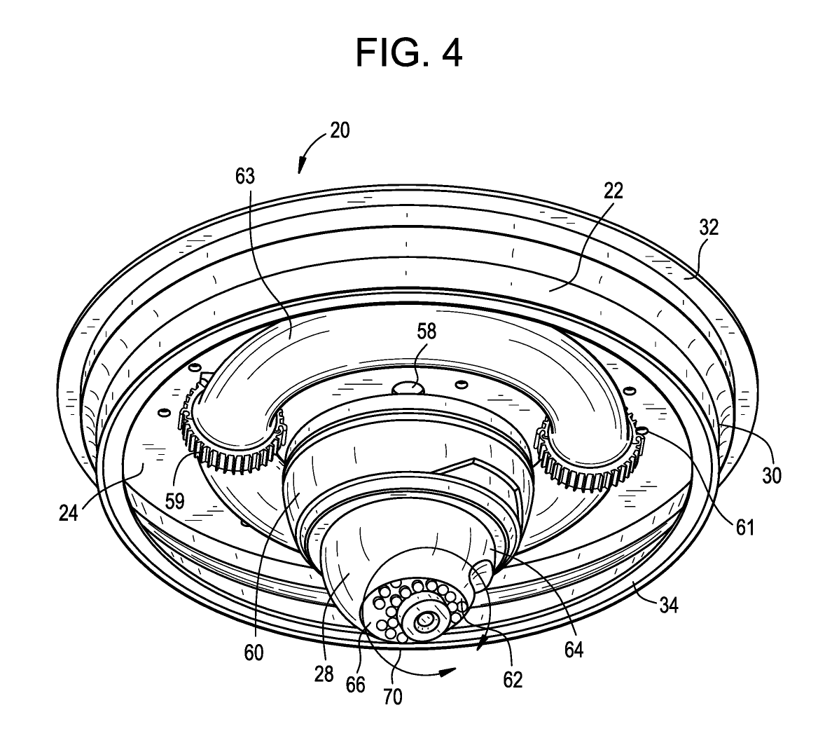

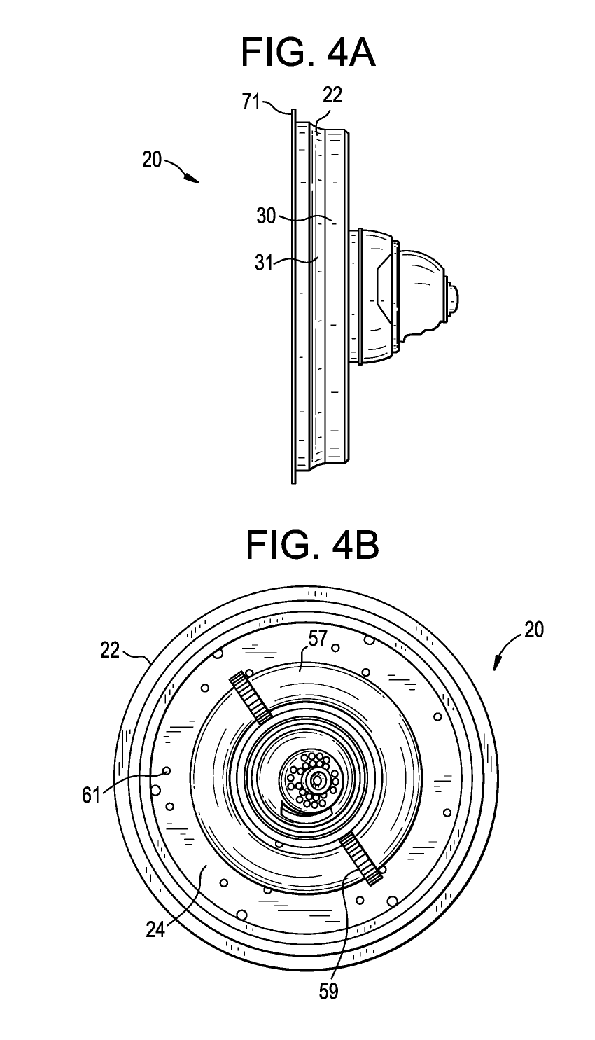

While the foregoing features of the housing 22 and backing substrate 24 have been described with the respect to the embodiment of FIG. 1, it will be appreciated that other suitable configurations, shapes, size, materials and so forth could be employed for these elements, as well as the other elements disclosed herein. In this regard, e.g., it is note that the dimensions (as measured in inches) noted in FIGS. 1 and 1A, as well as in FIGS. 4 and 4A further described below, are merely examples and other suitable diameters, radii, and so forth can be employed, according to embodiments.

As further shown in the embodiment of FIG. 1, a plurality of light emitting diode (LED) array boards 26 are located within the housing 22 and attached to the backing substrate 24. Each LED array board 26 is attached to the backing substrate 24 with the use of a suitable attaching mechanism. Examples include, but are not limited to, hardware such as screws, pins, other fasteners and so forth. Typically, stainless steel and/or aluminum fasteners such as the exemplary screws 44 shown in FIG. 1 are employed for corrosion resistance.

Each LED array board 26 is shown in the embodiment of FIG. 1 as comprising a first heat conduction substrate 40 and a second heat conduction substrate 42, wherein the second heat conduction substrate 42 (LED platform) is mounted on the first heat conduction substrate 40 with the use of suitable fastening mechanisms including but not limited to adhesives, screws, pins, other fasteners and so forth. The first and second heat conduction substrates 40, 42 are made of a suitable material, typically an aluminum or other suitable metal. As further shown in the embodiment of FIG. 1, the first heat conduction substrate 40 has a first substrate portion 46 receiving a fastener, e.g. screw 44, for attachment to the backing substrate 24. Thus, the first substrate portion 46 can be suitably positioned such as flatly positioned again the backing substrate 24 for a secure attachment thereto. The second substrate portion 48 can be at an angle such as 90 degrees as measured from the first substrate portion 46, as shown in FIG. 1. However, it will be appreciated that other configurations, shapes, angles and so forth may be employed.

As best seen in FIG. 1B, which is a front view of the energy efficient lighting and surveillance system 20 of FIG. 1, the LED array boards 26 are arranged or clustered in a suitable configuration or pattern depending upon the desired distribution of lighting. As noted above, recognized industry groups such as the Illuminating Engineering Society (IES) set predetermined illumination distribution standards including Type I through Type V distribution patterns. The pattern shown in FIG. 1B meets Type III distribution which is suitable for roads, general parking and other area lighting applications such as street lighting and so forth. Type III distribution has a lighting area width range up to approximately 2.75 times the mounting height. Type I distribution has a lighting area width range up to approximately 2 times the mounting height. Type II distribution has a lighting area width range up to approximately 1.75 times the mounting height. Type IV distribution has a lighting area width range over 2.75 times the mounting height (semicircular distribution) and Type V distribution has a lighting area width range to produce evenly distributed light in, e.g., a circular distribution.

More specifically, the Illuminating Engineering Society in its IES Lighting Handbook defines an illumination distribution as Type II when the street side segment of the half-maximum candlepower isocandela trace within the longitudinal range in which the point of maximum candlepower falls (short, medium or long) does not cross the 1.75 mounting height street side longitudinal roadway line. Type III is defined therein as where the street side segment of the half-maximum candlepower isocandela trace within the longitudinal range in which the point of maximum candlepower falls (short, medium or long) extends partly or entirely beyond the 1.75 mounting height street side longitudinal roadway line, but not farther than the 2.75 mounting height street side longitudinal roadway line. A Type IV distribution is defined as where the half-maximum candlepower isocandela trace within the longitudinal range in which the point of maximum candlepower falls (short, medium or long) extends partly or entirely beyond the 2.75 mounting height street side longitudinal roadway line. Examples of limits for typical half-maximum candlepower isocandela traces for Types II, III and illumination distributions are marked with reference numbers 55, 57 and 59, respectively, in FIGS. 1E, 1F and 1G. FIGS. 1E, 1F and 1G show standard Type II, Type III and Type IV IES Illumination distributions, respectively, that embodiments disclosed herein can be adjusted to produce in the horizontal plane. It is noted that other Types such as Type V (not shown) and so forth could also be achieved, according to embodiments. In FIGS. 1E, 1F, and 1G, reference 51 illustrates, e.g., a roadway with reference 53 generally representing, e.g., a roadside position for mounting of the assemblies and systems described herein on an elevated pole to provide the desired illumination.

Thus, while IES Type III distribution is met by the arrangement and board clustering shown in FIG. 1, embodiments of the invention are not so limited, as explained above. For example, the illumination distribution produced by embodiments of the invention can produce, e.g., a Type I, Type II, Type III, Type IV, and/or Type V illumination distribution as set by the Illuminating Engineering Society (IES), among others.

As best seen in FIG. 1D, the second heat conduction substrate 42 (LED platform) of the LED array board 26 comprises a plurality of LED bulbs 50 thereon. The LED platform 42 is typically conformally coated with a transparent conformal coating to protect against dust, moisture and so forth. In the exemplary embodiment shown in FIG. 1D, five single watt LED bulbs 50 are shown on each LED platform 42 which provides a heat sinking surface. However, it will be appreciated that more or less LED bulbs 50 can be employed, according to embodiments. Thus, embodiments can include on each LED platform 42, one LED bulb 50, two LED bulbs 50, three LED bulbs 50, four LED bulbs 50, more than five LED bulbs, and so forth. The LED platform 42 further comprises a printed circuit board 52 and has a first end 54 and a second end 56 and can comprise plug in connectors. The LED bulbs 50 are connected in a suitable form, and the units operate at, e.g., about 120 to about 277 volts (V) autosense and can function as a directed light source.

The energy efficient lighting and surveillance system 20 of FIG. 1 further comprises a surveillance device 28, e.g., a dome surveillance camera. The surveillance device 28 is mounted to the backing substrate 24 with the use of one or more suitable mounting devices such as the mounting arm 58 depicted in FIG. 1, according to embodiments. Securing mechanisms such as screws, other fasteners and so forth can be employed to secure the surveillance device 28 to the backing substrate 24. As further shown in FIG. 1, the surveillance device 28 extends, e.g., protrudes, from the housing 22, according to embodiments. Any suitable surveillance device 20 may be employed. Typically, as shown in FIG. 1, the surveillance device 28 is a dome shaped surveillance camera, which can provide still and video surveillance, according to embodiments. The camera embodiment depicted in FIG. 1 and best seen in FIG. 1C comprises a camera housing 60, a transparent cover (hemispherical in shape) 62, and a camera module 64. The cover 62 is coupled to the camera housing 60. The camera module 64 includes a casing 66 having a camera lens 68 mounted to a central portion of the camera module 64, and also has a plurality of LEDs 70 located around the camera lens 68. The casing 66 can be mounted with use of, e.g., brackets such that the casing 66 can be rotatably coupled thereto or fixed, according to embodiments. As best seen in FIG. 1A, the camera housing 60 is mounted on a flat, back diffusing lens 71.

According to embodiments, the surveillance device 28 includes an electrically operational digital recording system that feeds surveillance information to a user, and can utilize both wireless and hardwire connections.

In further accordance to embodiments, the surveillance device 28, e.g., surveillance camera, can comprise its own IP address and have a minimum rated IP classification 56 for, e.g., use in exterior and/or interior applications such that the camera is, e.g., vandal resistant, waterproof, watertight, flood resistance, weatherproof and so forth, according to embodiments. The surveillance device 28 can further comprise a wireless mesh network, according to embodiments. The surveillance device 28 can be managed with software that controls the device 28 alone or along with a plurality of devices 28. Typically, the surveillance device 28 has an IP classification of 66 or higher.

A non-limiting example of a suitable weatherproof dome IP camera for use, according to embodiments, in the energy efficient lighting and surveillance system 20 is Grandstream camera number GXV3662-HD sold by Grandstream Networks.

Referring now to FIG. 2, illustrated therein is a light fixture assembly 36 comprising a light fixture 38 and an energy efficient lighting and surveillance system 20 as shown in FIG. 1. Thus, the energy efficient lighting and surveillance system 20 comprises a housing 22, a backing substrate 24, a plurality of LED array boards 26 located within the housing 22 and attached to the backing substrate 24, and a surveillance device 28 extending from the housing 22 and attached to the backing substrate 24.

The light fixture 38 depicted in FIG. 2 comprises a base 72 having vertical support rods 74 supporting an upper dome 76. A decorative crown 78 and a cap 80 are provided for decorative features to enhance the look of the structure and provide an antique feel to the structure, according to embodiments. It is noted that the base 72, support rods 74, upper dome 76, decorative crown 78 and cap 80 are made of any suitable materials, and are typically metal and coated, as desired to enhance the look of the fixture 38, as well as provide corrosion protection and so forth depending upon use. For example, it is noted that the light fixtures assemblies and systems described herein are applicable to both indoor and outdoor use and thus the materials employed therefore including coatings can be tailored accordingly for such use. Thus, while the particular embodiment of FIG. 2 is shown as an indoor light fixture assembly 36, embodiments of the invention are not so limited.

As further shown in FIG. 2, located in an upper or roof portion of the light fixture 38 is the energy efficient lighting and surveillance system 20 as shown in FIG. 1, according to embodiments. As described above, the energy efficient lighting and surveillance system 20 comprises a housing 22, a backing substrate 24, a plurality of LED array boards 26 located within the housing 22 and attached to the backing substrate 24, and a surveillance device 28 extending from the housing 22 and attached to the backing substrate 24. The energy efficient lighting and surveillance system 20 is secured to the upper portion of the light fixture 38 by, e.g., attaching the backing substrate 24 to the light fixture with the use of attachment devices, such as screws, snaps, pins and other fasteners, as described above.

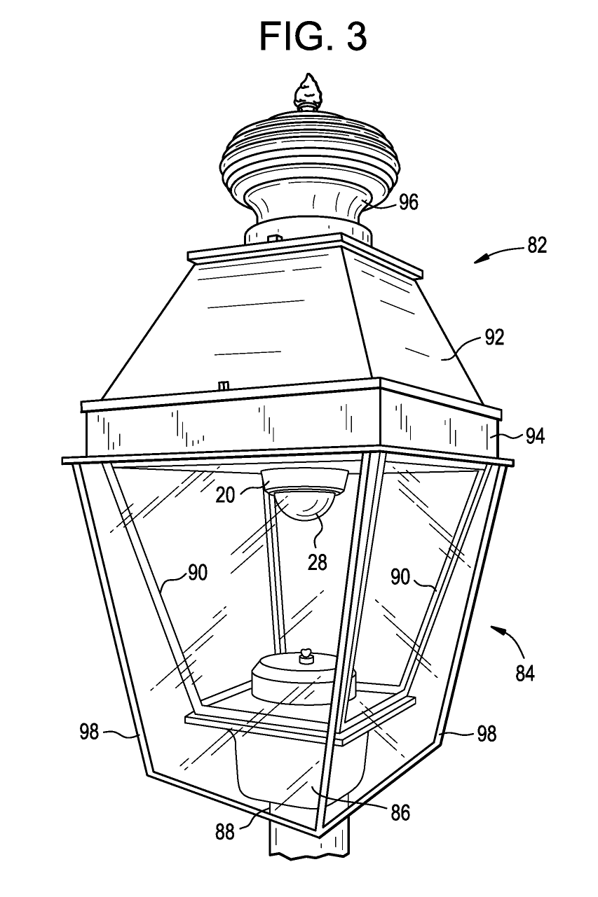

Referring now to FIG. 3, depicted therein is another light fixture assembly 82 comprising a light fixture 84 and an energy efficient lighting and surveillance system 20 as shown in FIG. 1. The light fixture assembly 82 depicted in FIG. 3 is primarily directed to outdoor street lighting, such as outdoor street lamp or pole lighting, however, embodiments of the invention are not so limited.

As further shown in FIG. 3, the light fixture 84 comprises a base 86 attached to a pole 88, such as a pole configured and suitable for outdoor street lighting. The base 86 is shown in FIG. 3 has having a plurality of vertically slanted support rods 90 supporting an upper section 92 of the light fixture assembly 82. A decorative rim 94 and a cap 96 are provided for decorative features to further enhance the look of the structure, according to embodiments. As further shown in the embodiment of FIG. 3, further rods 98 can support the upper section 92 and attach to the pole 88 below the base 86, although it will be appreciated that other locations, configurations and so forth of the rods 90, 98 are within the scope of embodiments of the invention. It is further noted that the foregoing features such as, e.g., the base 86, support rods 90, 98, decorative rim 94, cap 96 and pole 88 are made of any suitable material, and are typically metal and metallic coated, as desired to enhance the look of the fixture 84, as well as provide corrosion protection and so forth depending upon use.

As further shown in FIG. 3, located in an upper or roof portion of the light fixture 84 is the energy efficient lighting and surveillance system 20 as shown in FIG. 1, according to embodiments. As described above, the energy efficient lighting and surveillance system 20 comprises a housing 22, a backing substrate 24, a plurality of LED array boards 26 located within the housing 22 and attached to the backing substrate 24, and a surveillance device 28 extending from the housing 22 and attached to the backing substrate 24. The energy efficient lighting and surveillance system 20 is secured to the upper portion of the light fixture 84 by, e.g., attaching the backing substrate 24 to the light fixture with the use of attachment devices, such as screws, snaps, pins and other fasteners, as described above. Advantageously, embodiments according to the invention can be located at an elevation, e.g., on a street or walkway such that the focus of the surveillance is at the pedestrian level including about the 10 foot to 12 foot range as measured vertically from the ground or floor surface. However, embodiments are also applicable to the lighting and surveillance of vehicular traffic, and so forth.

Another advantage of embodiments of the invention is that the energy efficient lighting and surveillance systems disclosed herein can be applied to new lanterns and other lighting devices, as well as retrofit lanterns and other retrofit lighting devices. Moreover, the assemblies, systems and platforms described herein can advantageously light, as well as monitor pedestrian and vehicular traffic in a discrete and aesthetically pleasing manner.

A further advantage of embodiments of the invention is the ability to build modular LED platforms, wherein each platform can be tailored to fit inside a particular structure, e.g., lantern, and produce the desired light distribution, e.g., Type V, Type III and so forth.

Another advantage of embodiments of the invention includes providing energy savings lighting in combination with surveillance functionality. According to the inventor's knowledge, such divergent technologies and markets have not been before combined as herein and the disclosed embodiments satisfy a need to provide discreet, safety surveillance in combination with effectively lighting an area, while meeting energy savings requirements. In this regard, it is further noted that while the lighting optics of embodiments disclosed herein are primarily described above with respect to the use of LED bulbs 50, it is noted that in addition to LED lighting sources, the Department of Energy has also recognized induction lighting sources as energy savings sources. Accordingly, embodiments of the invention can also comprise the use of induction lighting in place of, or in addition to, the afore-referenced LED bulbs 50 in the platforms, systems and assemblies described herein as an effective alternative to traditional HID and fluorescent lighting. For example, LED and induction lighting provides energy saving advantages such as lowering energy costs due to longer life spans and durability of the lighting fixture assemblies and systems described herein and comprising such energy efficient lighting sources, according to embodiments.

For example, an induction light source such as an induction light or lamp typically does not employ internal electrodes, but instead emits ultraviolet (UV) radiation which is then converted to white light. Typically, mercury inside a gas bulb becomes charged or excited emitting the UV radiation subsequently converted into the visible light via, e.g., contacting phosphorus coated on the gas bulb. Instead of the use of an internal electrode, induction lighting typically uses a power source and a generator to produce a magnetic field which excites the gas. As a non-limiting example of use of an induction light source, FIG. 4 is a schematic, perspective view of an energy efficient lighting and surveillance system 20, according to embodiments. It is noted that like reference numerals and descriptions apply throughout the document. Thus, in contrast to the plurality of LED array boards 26 located within the housing 22, as described in FIG. 1, the system 20 of FIG. 4 comprises an induction light source 63 in place of the LED array boards 26. While the induction light source 63 is shown in FIG. 4 in the shape of a ring structure, other suitable shapes, sizes and so forth could be employed. An attachment device 59 is located around a portion of the ring structure for assisting in attaching the induction light source 63 to the backing structure 24. While two attachment rings 59 are shown in FIG. 4, more or less rings 59 could be employed and in other desired shapes, sizes and so forth for securing to backing substrate 24 by, e.g, screws, etc. As further shown in FIG. 4, backing substrate 24 also can comprise a plurality of attachment devices 61, such as screws and so forth, to assist in the locating and positioning of the system 20 within another device, such as that shown in FIGS. 2 and 3. FIGS. 4A and 4B illustrate, respectively, a side view of FIG. 4 and a front view of FIG. 4.

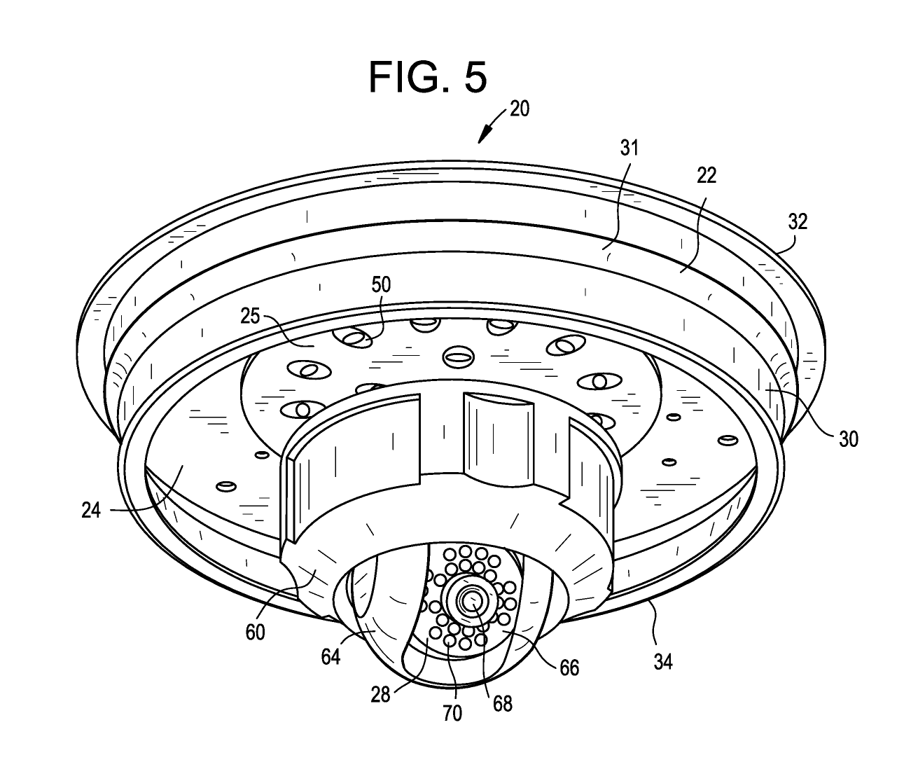

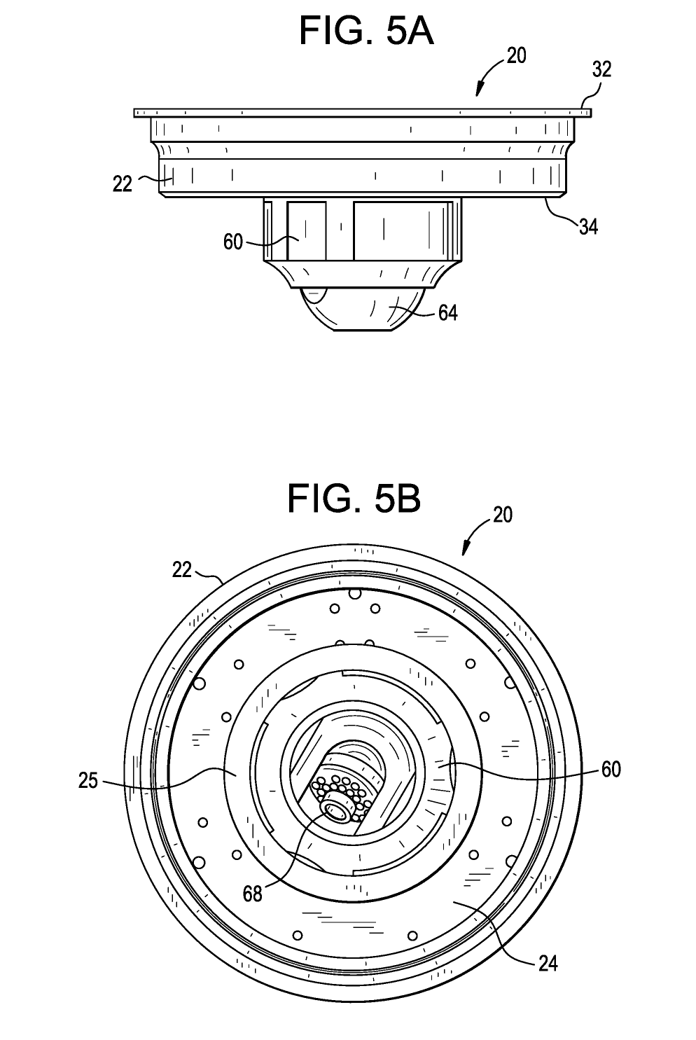

Referring now to the embodiment of the energy efficient lighting and surveillance system 20 set forth in FIG. 5, the features of this embodiment may be described as in FIG. 1. However, instead of a plurality of LED array boards 26, a mogul or medium base LED socket is employed. More particularly, the LED bulbs 50 of FIG. 5 are arranged on a central LED board 25 depicted in FIG. 5 as a LED board having a flat, circular or round shape and a medium or mogul (screw) base socket on its underside (not shown) for mounting to another structure such as backing 24 and/or a light fixture assembly. It is noted that any suitable medium or mogul base socket may be employed. In general, the term “medium” or standard typically refers to a base about 1 inch in diameter, and the term “mogul” typically refers to a screw type base slightly larger than a medium base, such as a base of about 1.5 inches in diameter. Thus, the medium or mogul base socket comprises a threaded base section for attaching, such as by screwing into, another structure, according to embodiments.

It will also be appreciated that while the LED board 25 attached to the medium or mogul socket on its underside is depicted in FIG. 5 as having a flat, circular or round shape, other shapes and configurations could be employed. As in the case of FIG. 1, the LED bulbs 50 of FIG. 5 are arranged in a suitable configuration or pattern depending upon the desired distribution of lighting. As described above, the embodiments described herein can produce, e.g., a Type I, Type II, Type III, Type IV, and/or Type V illumination distribution as set by the Illuminating Engineering Society (IES), among others. LED board 25 also is suitably positioned such as flatly positioned against the backing substrate 24.

As also in the case of FIG. 1, the surveillance device 28 of FIG. 5 can be mounted to the backing substrate 24 with the use of one or more mounting devices such as the mounting arm 58 best seen in FIG. 1. Securing mechanisms such as screws, other fasteners and so forth can be employed to secure the surveillance device 28 to the backing substrate 24.

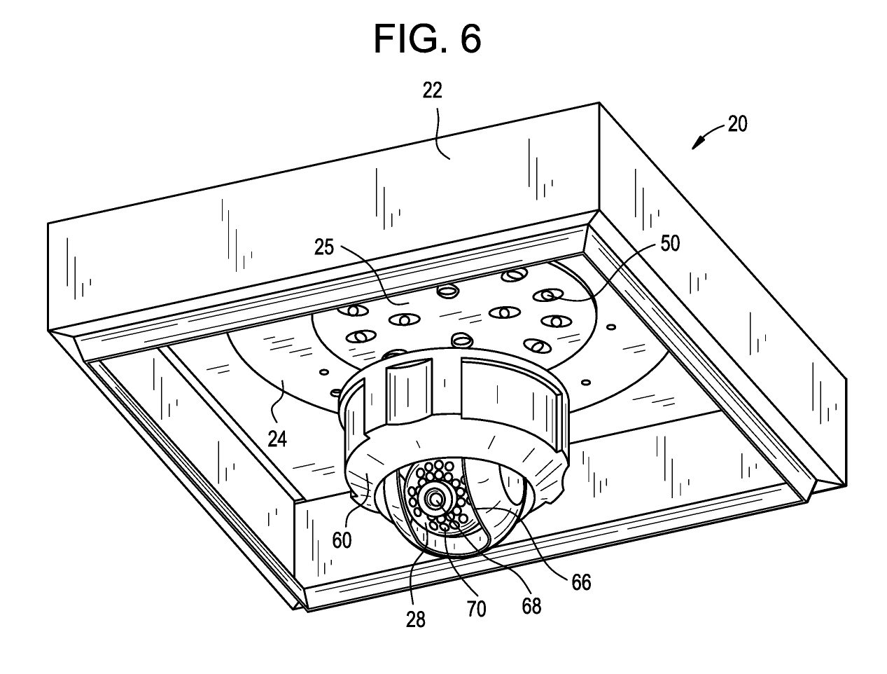

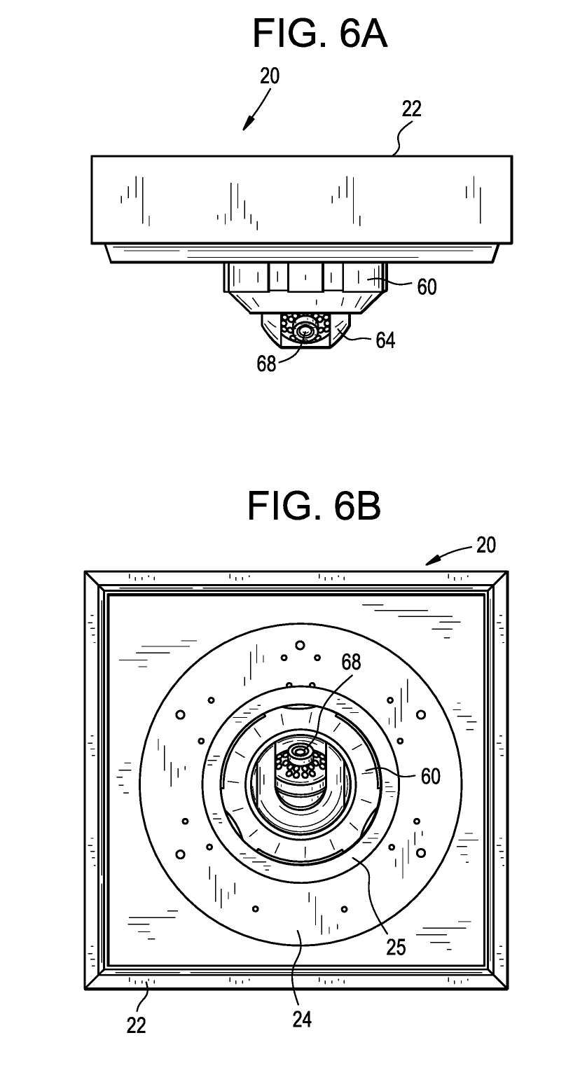

FIG. 6 illustrates an energy efficient lighting and surveillance system 20 as in the embodiment of FIG. 5, but depicting a hollow, square or square-like shaped housing 22. As explained above, housing 22 described herein is not limited to, e.g., the hollow, rim or ring-like structure shown in FIG. 1 as other suitable shapes and configurations could be employed therefore.

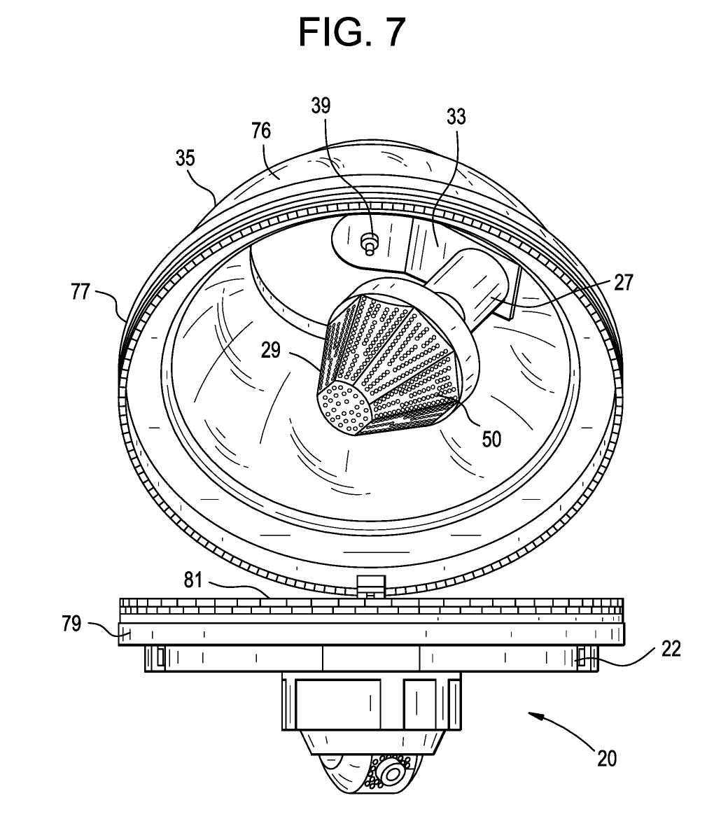

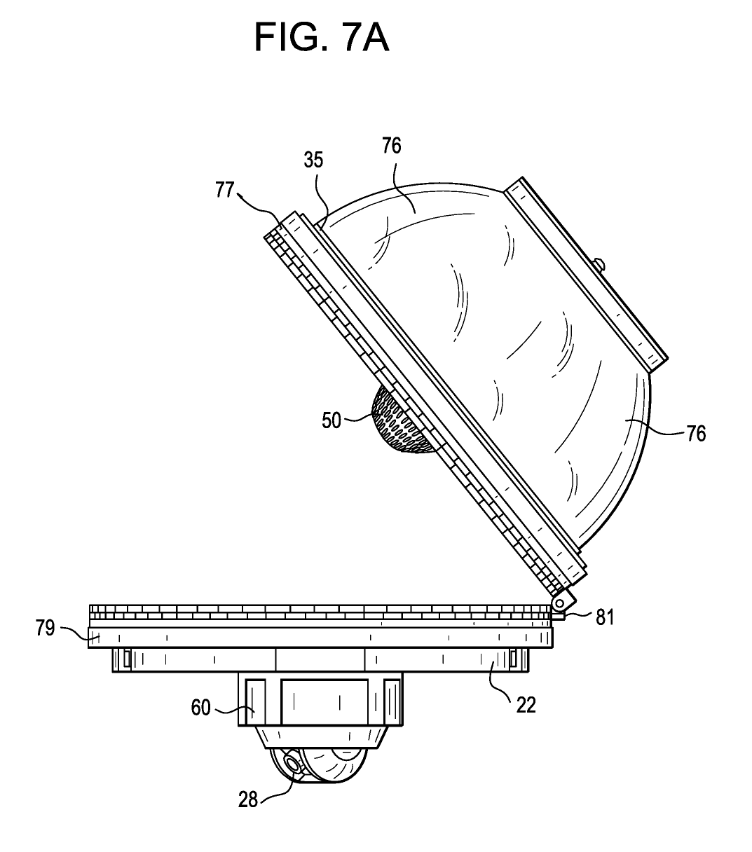

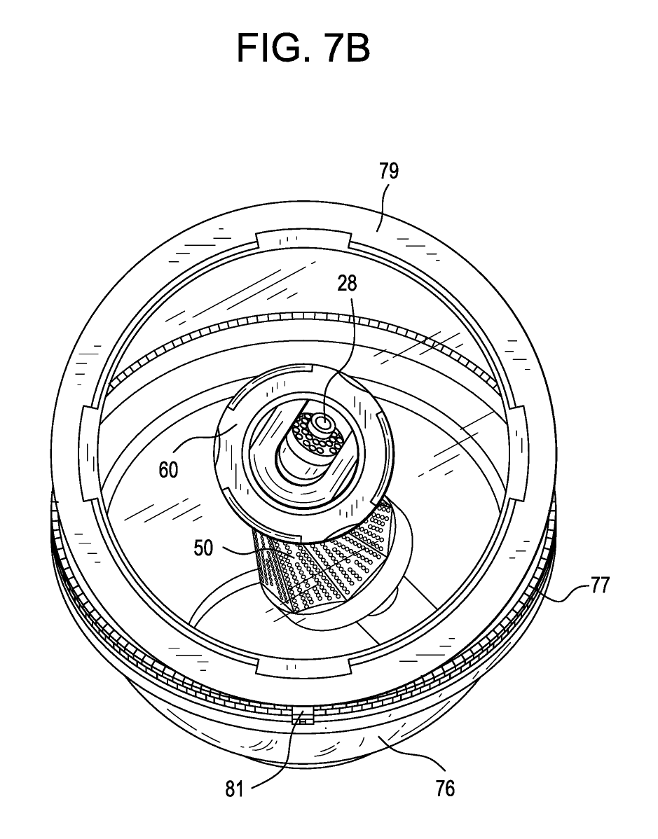

FIG. 7 illustrates another energy efficient lighting and surveillance system 20 as in FIG. 5 employing a medium or mogul base socket and LED lighting. However, in FIG. 7, the flat LED board 25 of FIG. 5 is not employed and instead the LED bulbs 50 are clustered into a protruding cone or cone-like structure 29 attached to medium or mogul socket 27.

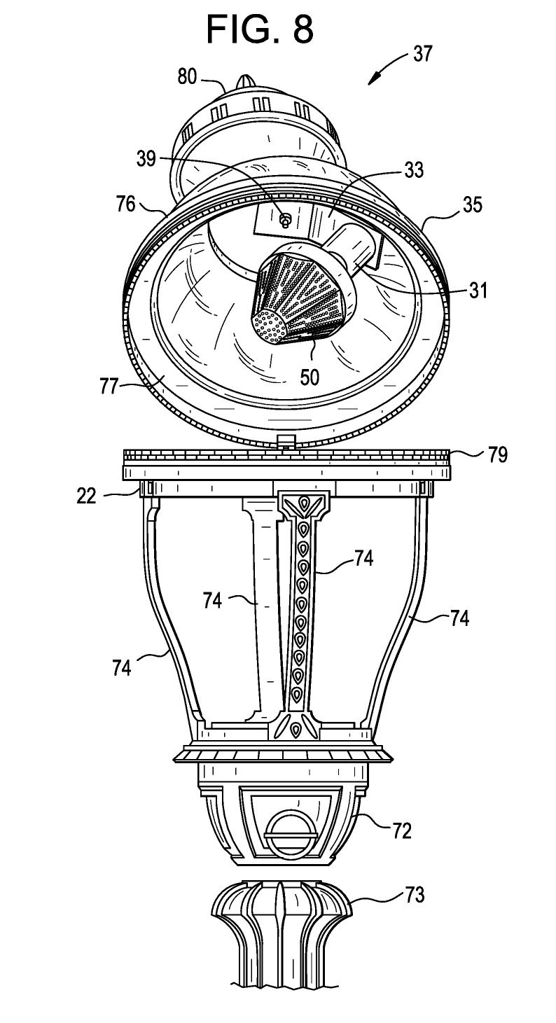

As also shown in FIG. 7, socket 27 is attached via arm 33 to an upper dome 76, which forms part of a light fixture 35 of a light fixture assembly 37 shown in FIG. 8, according to embodiments and further described below. Any suitable securing mechanisms may be employed such as screws 39 and other fasteners to attach the arm 33 to the light fixture 35. The upper dome 76 is attached to an upper rim portion 77 configured to mate with a lower rim portion 79. While the upper and lower rim portions 77, 79 are depicted in FIGS. 7, 7A and 7B as having a matching hollow circular shape, it will be appreciated that other shapes and configurations could be employed as desired. The upper rim portion 77 and lower rim portion 79 are attached to each other such as with use of a suitable hinge or other pivoting mechanism 81 as best seen in the exemplary embodiment of FIG. 7, which allows the two structures to be opened and closed for access, as desired.

It is noted that that the afore-described socket 27 is noted limited to use with the LED lighting described above. For example, socket 27 may also be employed in embodiments using induction lighting, e.g., as in the embodiment shown in FIG. 4. As a non-limiting example thereof, socket 27 may be located on the underside of induction light source 63 shown in FIG. 4 for mounting to another structure such as backing 24 and/or a light fixture assembly.

FIG. 8 illustrates therein a light fixture assembly 37 comprising the light fixture 35 and the energy efficient lighting and surveillance system 20 of FIG. 7. The light fixture 35 comprises, as also in the embodiment of FIG. 2, a base 72 having vertical support rods 74 supporting upper dome 76. The base 72 can be secured to post 73, such as an outdoor street light post, by any suitable securing mechanism such as screws, adhesive, welding, proper positioning thereon, and so forth. A cap 80 positioned on the upper dome 76 is provided for decorative features to enhance the look of the structure, according to embodiments.

It is noted that the base 72, support rods 74, upper dome 76 and cap 80 are made of any suitable materials, and are typically metal and coated, as desired to enhance the look of the fixture 35, as well as provide corrosion protection depending upon use. For example, as explained above, the light fixtures and assemblies described herein are applicable to both indoor and outdoor use and thus the materials employed therefore including coatings can be tailored accordingly for such use. Thus, while the particular embodiment of FIG. 8 is shown as an outdoor light fixture assembly 37, embodiments of the invention are not so limited.

Some embodiments according to the invention are described below:

### Embodiment 1

An energy efficient lighting and surveillance system comprising:

a housing;

a backing substrate;

a plurality of light emitting diode (LED) array boards located within the housing and attached to the backing substrate; and

a surveillance device extending from the housing and attached to the backing substrate.

### Embodiment 2

The energy efficient lighting and surveillance system of embodiment 1, wherein the housing is an aluminum rim shaped housing and the backing substrate is secured within the housing.

### Embodiment 3

The energy efficient lighting and surveillance system of embodiment 2, wherein each of the plurality of LED array boards comprises a first heat conduction substrate and a second heat conduction substrate, the second heat conduction substrate being mounted on the first heat conduction substrate and comprising a plurality of LED bulbs thereon.

### Embodiment 4

The energy efficient lighting and surveillance system of embodiment 3, wherein the plurality of LED array boards are clustered to produce a recognized illumination distribution standard as set by the Illuminating Engineering Society.

### Embodiment 5

The energy efficient lighting and surveillance system of embodiment 4, wherein the produced illumination distribution standard is Type I, Type II, Type III, Type IV or Type V as set by the Illuminating Engineering Society.

### Embodiment 6

The energy efficient lighting and surveillance system of embodiment 5, wherein the surveillance device is a dome surveillance camera.

### Embodiment 7

The energy efficient lighting and surveillance system of embodiment 6, wherein the dome surveillance camera is secured to the backing substrate with an attachment arm.

### Embodiment 8

A light fixture assembly comprising:

a light fixture; and

the energy efficient lighting and surveillance system of embodiment 7.

### Embodiment 9

A light fixture assembly comprising:

a light fixture; and

an energy efficient lighting and surveillance system attached to the light fixture, the energy efficient lighting and surveillance system comprising a housing, a backing substrate, a plurality of LED array boards located within the housing and attached to the backing substrate, and a surveillance device extending from the housing and attached to the backing substrate.

### Embodiment 10

The light fixture assembly of embodiment 9, wherein the light fixture comprises:

a base;

a dome;

a support rod extending from opposite sides of the base and supporting the dome, wherein the energy efficient lighting and surveillance system is positioned and secured to an upper portion of the light fixture located below the dome.

### Embodiment 11

The light fixture assembly of embodiment 10, wherein the backing substrate of the energy efficient lighting and surveillance system is secured to the upper portion of the light fixture below the dome with mechanical fasteners.

### Embodiment 12

The light fixture assembly of embodiment 11, wherein the dome comprises a decorative crown.

### Embodiment 13

The light fixture assembly of embodiment 11, wherein each of the plurality of LED array boards comprises a first heat conduction substrate and a second heat conduction substrate, the second heat conduction substrate being mounted on the first heat conduction substrate and comprising a plurality of LED bulbs thereon, and wherein the plurality of LED array boards are clustered to produce a recognized illumination distribution standard as set by the Illuminating Engineering Society.

### Embodiment 14

The light fixture assembly of embodiment 13, wherein the produced illumination distribution standard is Type I, Type II, Type III, Type IV or Type V as set by the Illuminating Engineering Society.

### Embodiment 15

The light fixture assembly of embodiment 14, wherein the surveillance device is a dome surveillance camera.

### Embodiment 16

The light fixture assembly of embodiment 9, wherein the light fixture comprises:

a base;

a pole attached to the base;

an upper section;

a plurality of support rods extending from the base and supporting the upper section, the upper section comprising a decorative rim and cap,

wherein the energy efficient lighting and surveillance system is secured to the upper section of the lighting fixture and located below the decorative rim.

### Embodiment 17

The light fixture assembly of embodiment 16, wherein each of the plurality of LED array boards comprises a first heat conduction substrate and a second heat conduction substrate, the second heat conduction substrate being mounted on the first heat conduction substrate and comprising a plurality of LED bulbs thereon, and wherein the plurality of LED array boards are clustered to produce a recognized illumination distribution standard as set by the Illuminating Engineering Society.

### Embodiment 18

The light fixture assembly of embodiment 17, wherein the produced illumination distribution standard is Type I, Type II, Type III, Type IV or Type V as set by the Illuminating Engineering Society.

### Embodiment 19

An energy efficient lighting and surveillance system comprising:

a housing;

a backing substrate;

an induction lighting source located within the housing and attached to the backing substrate; and

a surveillance device extending from the housing and attached to the backing substrate.

### Embodiment 20

The energy efficient lighting and surveillance system of embodiment 19, wherein the system is configured to produce a recognized illumination distribution standard as set by the Illuminating Engineering Society, and the produced illumination distribution standard is Type I, Type II, Type III, Type IV or Type V as set by the Illuminating Engineering Society.

### Embodiment 21

An energy efficient lighting and surveillance system comprising:

a housing; and

a light source located within the housing; the light source comprising at least one of i) a flat light emitting diode (LED) array board with a plurality of LED bulbs thereon and having a medium or mogul base socket and ii) a protruding structure comprising a plurality of LED bulbs thereon and having a medium or mogul base socket; and a surveillance device extending from the housing.

### Embodiment 22

A light fixture assembly comprising:

a light fixture; and

the energy efficient lighting and surveillance system of embodiment 21.

### Embodiment 23

The energy efficient lighting and surveillance system of embodiment 19, wherein the induction lighting source comprises a medium or mogul base socket.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

Moreover, it is noted that the features and elements described herein can be employed in any combination with other features and/or elements, embodiments and so forth described herein.

What is claimed is:

1. An energy efficient lighting and surveillance system comprising:
a housing;
a backing substrate;
a plurality of light emitting diode (LED) array boards located within the housing and attached to the backing substrate; and
a surveillance device extending from the housing and attached to the backing substrate.

2. The energy efficient lighting and surveillance system of claim 1, wherein the housing is an aluminum rim shaped housing and the backing substrate is secured within the housing.

3. The energy efficient lighting and surveillance system of claim 2, wherein each of the plurality of LED array boards comprises a first heat conduction substrate and a second heat conduction substrate, the second heat conduction substrate being mounted on the first heat conduction substrate and comprising a plurality of LED bulbs thereon.

4. The energy efficient lighting and surveillance system of claim 3, wherein the plurality of LED array boards are clustered to produce a recognized illumination distribution standard as set by the Illuminating Engineering Society.

5. The energy efficient lighting and surveillance system of claim 4, wherein the produced illumination distribution standard is Type I, Type II, Type III, Type IV or Type V as set by the Illuminating Engineering Society.

6. The energy efficient lighting and surveillance system of claim 5, wherein the surveillance device is a dome surveillance camera.

7. The energy efficient lighting and surveillance system of claim 6, wherein the dome surveillance camera is secured to the backing substrate with an attachment arm.

8. A light fixture assembly comprising:
a light fixture; and
the energy efficient lighting and surveillance system of claim 7.

9. A light fixture assembly comprising:
a light fixture having a first perimeter;
a metallic housing having a second perimeter that is located radially inward of the first perimeter, the metallic housing being secured to and positioned under the light fixture, the metallic housing being a heat sink for the light fixture; and
an energy efficient lighting and surveillance system comprising:
a flat backing substrate attached to the light fixture within the metallic housing radially inward of the second perimeter of the metallic housing;
a surveillance device attached to the flat backing substrate and extending therefrom; and
a plurality of LED array boards attached to the flat backing substrate and located around the surveillance device.

10. The light fixture assembly of claim 9, wherein the light fixture comprises:
a base; and
a support rod extending from each of two opposite sides of the base, wherein the energy efficient lighting and surveillance system is positioned and secured to an upper portion of the light fixture.

11. The light fixture assembly of claim 10, wherein the backing substrate of the energy efficient lighting and surveillance system is secured to the upper portion of the light fixture with mechanical fasteners.

12. The light fixture assembly of claim 11, wherein the dome comprises a decorative crown.

13. The light fixture assembly of claim 11, wherein each of the plurality of LED array boards comprises a first heat conduction substrate and a second heat conduction substrate, the second heat conduction substrate being mounted on the first heat conduction substrate and comprising a plurality of LED bulbs thereon, and wherein the plurality of LED array boards are clustered to produce a recognized illumination distribution standard as set by the Illuminating Engineering Society.

14. The light fixture assembly of claim 13, wherein the produced illumination distribution standard is Type I, Type II, Type III, Type IV or Type V as set by the Illuminating Engineering Society.

15. The light fixture assembly of claim 14, wherein the surveillance device is a dome surveillance camera.

16. The light fixture assembly of claim 9, wherein the light fixture comprises:
a base;
a pole attached to the base;
an upper section; and
a plurality of support rods extending from the base and supporting the upper section, the upper section comprising a decorative rim and cap,
wherein the energy efficient lighting and surveillance system is secured to the upper section of the lighting fixture and located below the decorative rim.

17. The light fixture assembly of claim 16, wherein each of the plurality of LED array boards comprises a first heat conduction substrate and a second heat conduction substrate, the second heat conduction substrate being mounted on the first heat conduction substrate and comprising a plurality of LED bulbs thereon, and wherein the plurality of LED array boards are clustered to produce a recognized illumination distribution standard as set by the Illuminating Engineering Society.

18. The light fixture assembly of claim 17, wherein the produced illumination distribution standard is Type I, Type II, Type III, Type IV or Type V as set by the Illuminating Engineering Society.

19. The light fixture assembly of claim 9, further comprising an induction lighting source located within the housing and attached to the flat backing substrate.
